(19) United States
(12) Patent Application Publication
(10) Pub. No.: US 2020/0170199 A1
(43) Pub. Date: Jun. 4, 2020

(54) DEVICE AND METHOD OF USE FOR COVERING AND PROTECTING PLANTS

(71) Applicant: Elizabeth Barrera Rush, San Antonio, TX (US)

(72) Inventor: Elizabeth Barrera Rush, San Antonio, TX (US)

(21) Appl. No.: 16/209,931

(22) Filed: Dec. 4, 2018

(51) Int. Cl. A01G 13/04

(52) U.S. Cl. CPC A01G 13/043; A01G 2013/046

(57) ABSTRACT

Disclosed herein is a device for protecting and covering plants. More specifically, the present invention generally relates to a device and method of use for covering and protecting plants from environmental elements by utilizing a height and width adjustable material covering. In one embodiment the device is comprised of a vertical support member, arm members, slider members, and covering members. In another embodiment, the device for protecting and covering plants is further comprised of cap members.

### CROSS-REFERENCE TO RELATED APPLICATIONS

Not applicable

### STATEMENT REGARDING FEDERALLY SPONSORED RESEARCH OR DEVELOPMENT

Not applicable

### THE NAMES OF THE PARTIES TO A JOINT RESEARCH AGREEMENT

Not applicable INCORPORATING-BY-REFERENCE OF MATERIAL SUBMITTED ON A COMPACT DISC

Not applicable

### SEQUENCE LISTING

Not applicable

### FIELD OF THE INVENTION

The present invention generally relates to a device and method of use for covering and protecting plants from environmental elements. More specifically, the present invention generally relates to a device and method of use for covering and protecting plants from environmental elements by utilizing a height and width adjustable material covering.

### BACKGROUND OF THE INVENTION

Without limiting the scope of the disclosed device, the background is described in connection with a novel device and method of use for covering and protecting plants from environmental elements by utilizing a height and width adjustable material covering.

To help alleviate these issues, several approaches in the prior art have been taken to protect plants. For example, it is common practice in the art to utilize blankets of material such as sheets, towels, quilts, and plant blankets. These items require direct overlay and contact with the plants causing the item to be soiled. In addition, because of the direct contact with the plant, the plant is subjected to possible damage. If direct contact is to be avoided, an additional pole, stake, or support is required to be positioned to hold the blanket of material. Often times this is cumbersome and is not easily positioned. In addition, you may have plants of various heights and widths. This may be due to various plants or the actual growth of a plant.

While all of the aforementioned devices may fulfill their unique purposes, none of them fulfill the need for a practical, effective, and efficient means for covering and protecting plants of various sizes from environmental elements.

Therefore, the present invention proposes a novel device and method of use for covering and protecting plants form environmental elements by utilizing a height and width adjustable material covering.

### BRIEF SUMMARY OF THE INVENTION

The present invention, therefore, provides for a device and method of use for covering and protecting plants from environmental elements. More specifically, the present invention generally relates to a device and method of use for covering and protecting plants form environmental elements by utilizing a height and width adjustable material covering. In one embodiment the device is comprised of a vertical support member, arm members, slider members, and covering members. The vertical support member in an embodiment is configured at the bottom end to allow the device to be placed into the ground or dirt without any support from the plant allowing the device to stand upright. In further embodiments the vertical support member is configured at the bottom end to be structured as a spike or terminating as a point. In further embodiments, the covering members are releasably attached. In another embodiment, the device for protecting and covering plants is further comprised of cap members.

In summary, the present invention discloses a novel device and method of use for covering and protecting plants form environmental elements by utilizing a height and width adjustable material covering.

### BRIEF DESCRIPTION OF THE SEVERAL VIEWS OF THE DRAWINGS

For a more complete understanding of the features and advantages of the present invention, reference is now made to the detailed description of the invention along with the accompanying figures in which:

FIG. 1 is a perspective view of the device for protecting and covering plants in accordance with embodiments of the disclosure;

FIG. 2 is a front view of the device for protecting and covering plants in accordance with embodiments of the disclosure;

FIG. 3 is a left view of the device for protecting and covering plants in accordance with embodiments of the disclosure;

FIG. 4 is a right view of the device for protecting and covering plants in accordance with embodiments of the disclosure;

FIG. 5 is a back view of the device for protecting and covering plants in accordance with embodiments of the disclosure;

FIG. 6 is a top view of the device for protecting and covering plants in accordance with embodiments of the disclosure;

FIG. 7 is a bottom view of the device for protecting and covering plants in accordance with embodiments of the disclosure;

FIG. 8 is a perspective view illustrating a width adjustment of the device for protecting and covering plants in accordance with embodiments of the disclosure;

FIG. 9 is a perspective view illustrating a height adjustment of the device for protecting and covering plants in accordance with embodiments of the disclosure;

FIG. 10 is a perspective view illustrating the coverings attached to the device for protecting and covering plants in accordance with embodiments of the disclosure.

### DETAILED DESCRIPTION OF THE INVENTION

Disclosed herein is an improved device and method of use for covering and protecting plants from environmental elements. The numerous innovative teachings of the present invention will be described with particular reference to several embodiments (by way of example, and not of limitation).

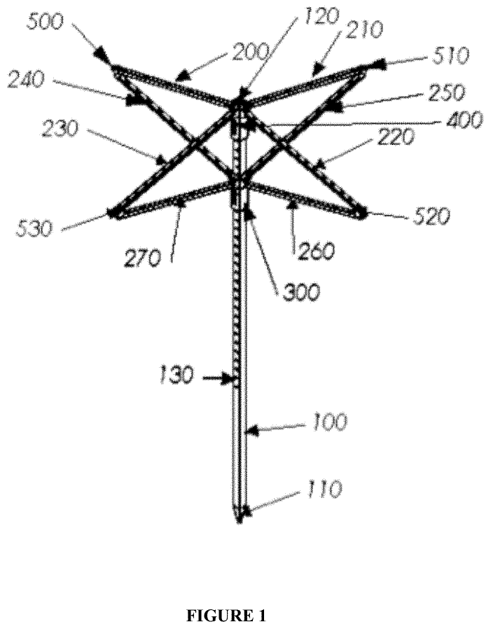

Reference is first made to FIG. 1, a perspective view of the device for protecting and covering plants in accordance with embodiments of the disclosure. In one embodiment the device is comprised of a vertical support member 100, arm members 200, 210, 220, 230, 240, 250, 260, 270, slider members 300, 400, and covering members. The vertical support member 100 in an embodiment is configured at the bottom end 110 to allow the device to be placed into or on the ground or dirt or soil without any support from the plant allowing the device to stand upright. In further embodiments the vertical support member 100 is configured at the bottom end 110 to be structured as a spike or terminating as a point. In further embodiments, the covering members are releasably attached. In another embodiment, the device for protecting and covering plants is further comprised of cap members 500, 510, 520, 530. The cap members 500, 510, 520, 530 are hinges allowing the arms to rotate in relation to each other. For example, arm member 200 and arm member 240 are connected to cap member 500 and both arm members are able to rotate in relation to each other at the cap member 500. Slider members in an embodiment can retain a fixed position on vertical support member by locking into the slots or holes 130 which are positioned along a portion of the length of the vertical support member 100. In other embodiments the device may be comprised of only two or three arm members. An arm member is 200 and 240, or 210 and 250, or 220 and 260, or 230 and 270. Each arm member has an upper arm member 200, 210, 220, 230 and a lower arm member 240, 250, 260, 270. The upper arm members 200, 210, 220, 230 are connected to the upper slider member 400 and the lower arm members 240, 250, 260, 270 are connected to the lower slider member 300. In an embodiment the upper and lower arm member's connection points to the slider members are hinges allowing the arm members to rotate along a vertical plane. In other embodiments, the device may be comprised of 5 or more arm members.

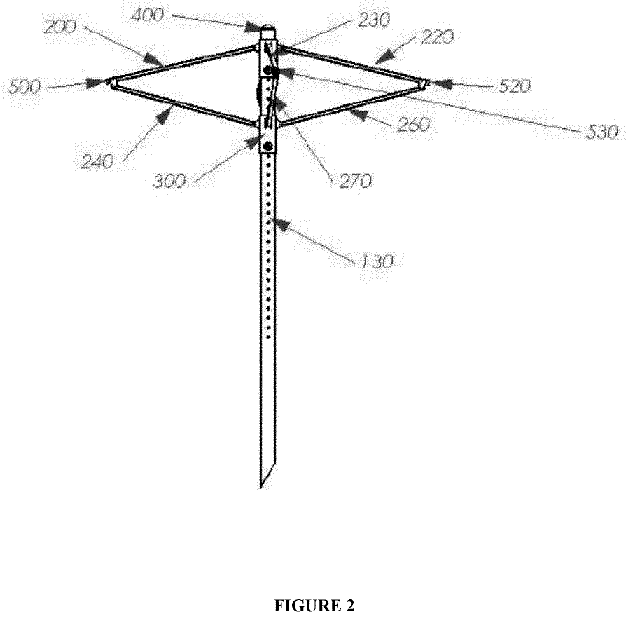

Reference is next made to FIG. 2, a front view of the device for protecting and covering plants in accordance with embodiments of the disclosure.

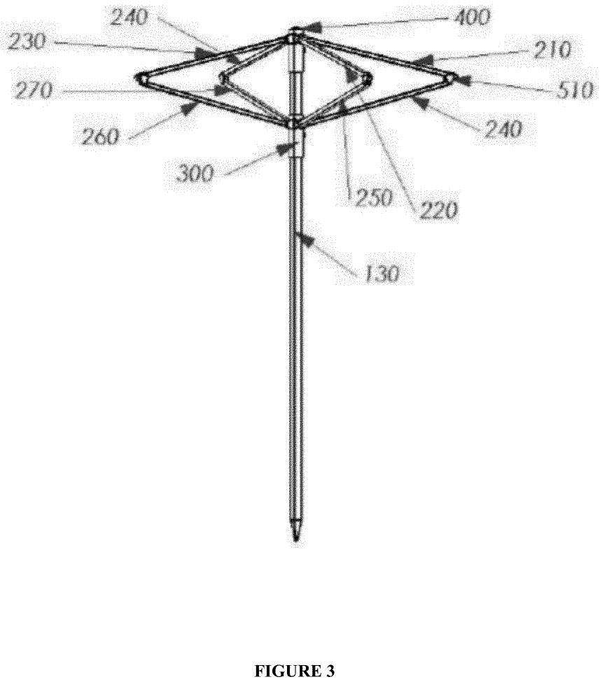

Reference is now made to FIG. 3, a left view of the device for protecting and covering plants in accordance with embodiments of the disclosure.

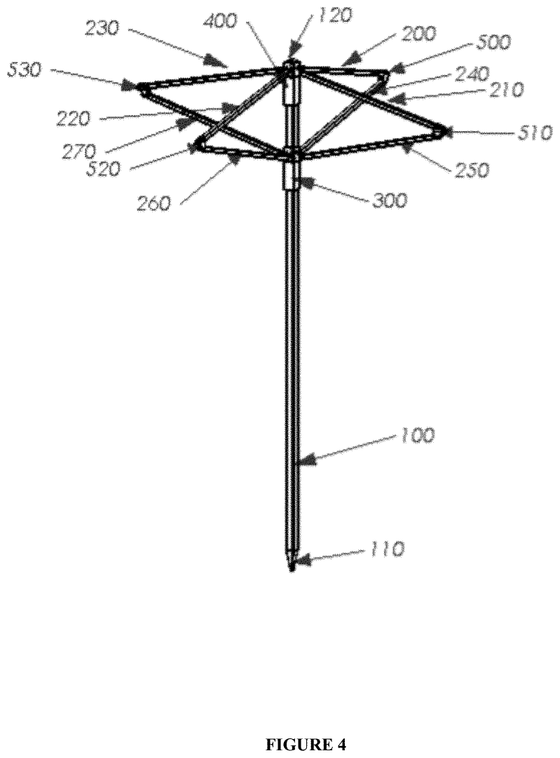

Reference is next made to FIG. 4, a right view of the device for protecting and covering plants in accordance with embodiments of the disclosure.

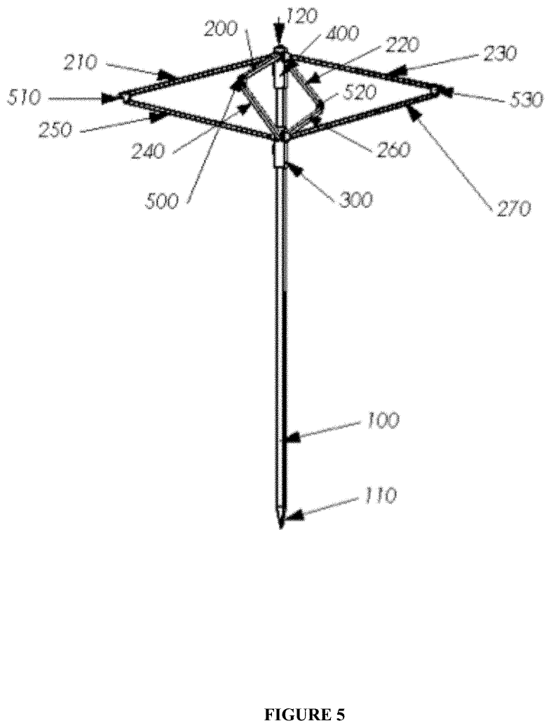

Reference is now made to FIG. 5, a back view of the device for protecting and covering plants in accordance with embodiments of the disclosure.

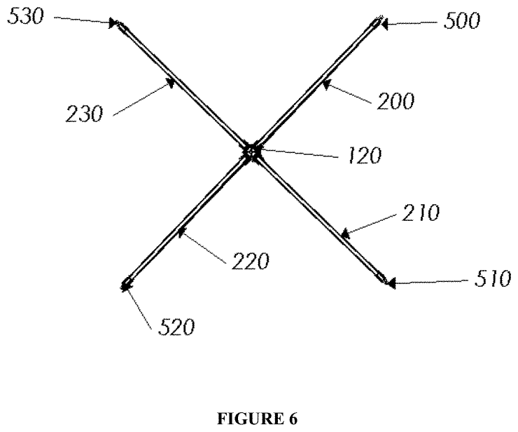

Reference is next made to FIG. 6, a top view of the device for protecting and covering plants in accordance with embodiments of the disclosure.

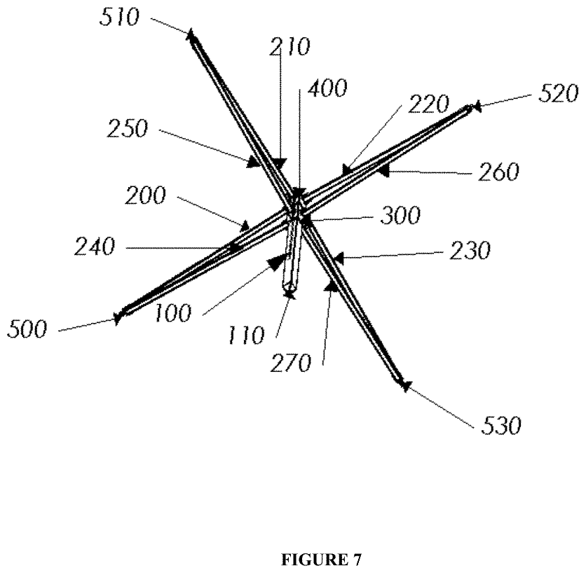

Reference is now made to FIG. 7, a bottom view of the device for protecting and covering plants in accordance with embodiments of the disclosure.

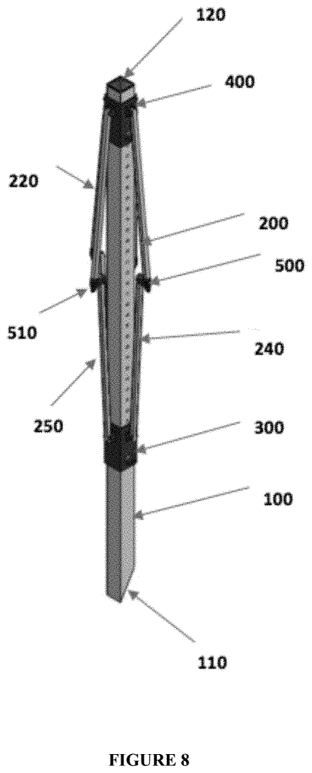

Reference is now made to FIG. 8, a perspective view illustrating a width adjustment of the device for protecting and covering plants in accordance with embodiments of the disclosure. Illustrated in this figure is how a width adjustment may be made with the device. The top slider 400 and the bottom slider 300 are distanced apart on the vertical support member 100 bringing the arm member 200, 210, 220, 230, 240, 250, 260, 270 in towards the vertical support member 100. As can be seen, the more the top slider 400 and the bottom slider 300 are distanced apart on the vertical support member 100 the width coverage of the covering members is decreased. In addition, the more the top slider 400 and the bottom slider 300 are brought closer together on the vertical support member 100 the width coverage of the covering members is increased.

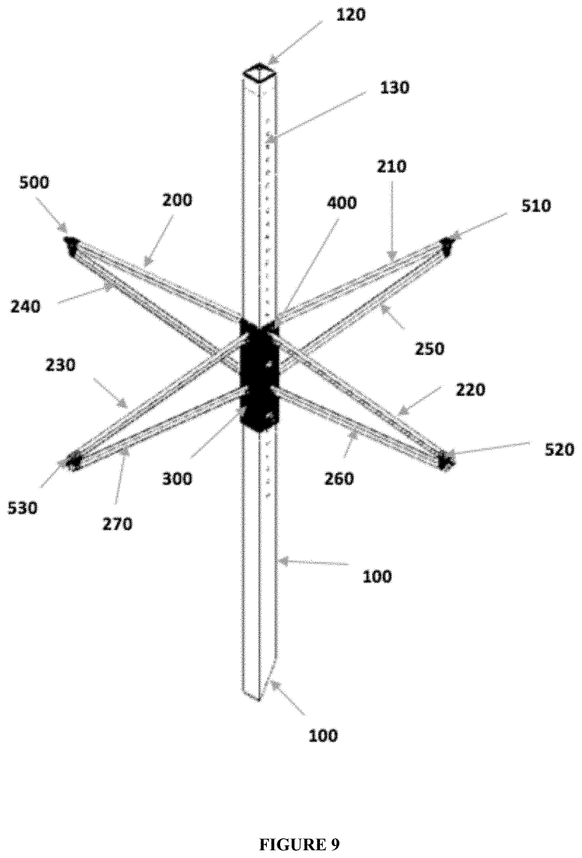

Reference is now made to FIG. 9, a perspective view illustrating a height adjustment of the device for protecting and covering plants in accordance with embodiments of the disclosure. Illustrated in this figure is how a height adjustment may be made with the device. The top slider 400 and the bottom slider 300 are moved up and down the vertical support member 100 but kept the same distance apart on the vertical support member 100 maintaining the same arm member 200, 210, 220, 230, 240, 250, 260, 270 distance from the vertical support member 100.

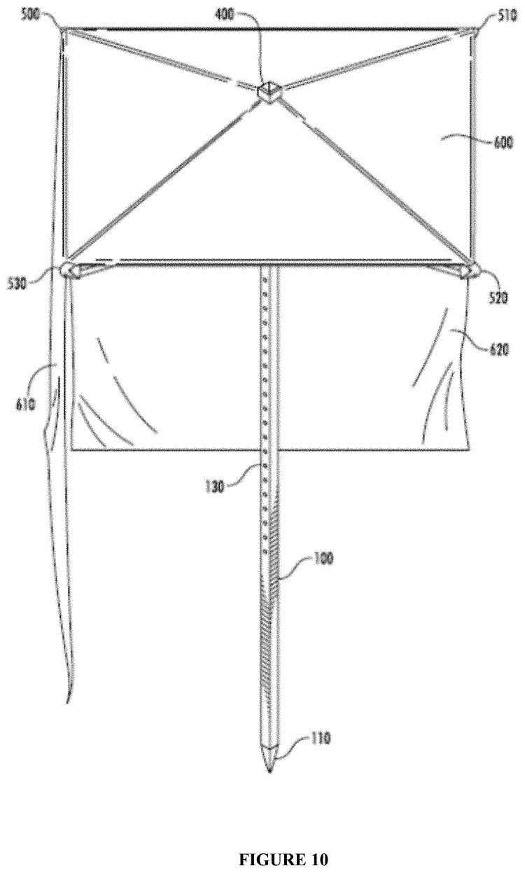

Reference is now made to FIG. 10, a perspective view illustrating the coverings attached to the device for protecting and covering plants in accordance with embodiments of the disclosure. In this figure the covering members 600, 610, 620 are shown attached. In this illustration we see the back covering member 620, the left side covering member 610, and the top covering member 600 attached. The covering members may be attached to the arm members 200, 210, 220, 230, 240, 250, 260, 270 through various means such as but not limited to hook and looks fasteners, buttons, and ties. In other embodiments the covering members maybe attached to the cap members 500, 510, 520, 530 or the top of the top slider 120. The material of the covering members may be a flexible or rigid material such as but not limited to fabric, polymers, metals, and wood. In additional embodiments, covering members 630 and 640 would cover the remaining sides.

In brief, the invention is directed to a device and method of use for covering and protecting plants from environmental elements.

The disclosed device and method of use is generally described, with examples incorporated as particular embodiments of the invention and to demonstrate the practice and advantages thereof. It is understood that the examples are given by way of illustration and are not intended to limit the specification or the claims in any manner.

To facilitate the understanding of this invention, a number of terms may be defined below. Terms defined herein have meanings as commonly understood by a person of ordinary skill in the areas relevant to the present invention. Terms such as “a”, “an”, and “the” are not intended to refer to only a singular entity, but include the general class of which a specific example may be used for illustration. The terminology herein is used to describe specific embodiments of the invention, but their usage does not delimit the disclosed device or method of use, except as may be outlined in the claims.

Alternative applications for this invention include using this device or method of use in any application where an object or item is to be protected from environmental elements. Consequently, any embodiments comprising a one piece or multi piece device having the structures as herein disclosed with similar function shall fall into the coverage of claims of the present invention and shall lack the novelty and inventive step criteria.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific device and method of use described herein. Such equivalents are considered to be within the scope of this invention and are covered by the claims.

All publications and patent applications mentioned in the specification are indicative of the level of those skilled in the art to which this invention pertains. All publications and patent application are herein incorporated by reference to the same extent as if each individual publication or patent application was specifically and individually indicated to be incorporated by reference.

In the claims, all transitional phrases such as “comprising,” “including,” “carrying,” “having,” “containing,” “involving,” and the like are to be understood to be open-ended, i.e., to mean including but not limited to. Only the transitional phrases “consisting of” and “consisting essentially of,” respectively, shall be closed or semi-closed transitional phrases.

The device and/or methods of use disclosed and claimed herein can be made and executed without undue experimentation in light of the present disclosure. While the device and methods of use of this invention have been described in terms of preferred embodiments, it will be apparent to those skilled in the art that variations may be applied to the device and/or methods of use and in the steps or in the sequence of steps of the method of use described herein without departing from the concept, spirit, and scope of the invention.

More specifically, it will be apparent that certain components, which are both shape and material related, may be substituted for the components described herein while the same or similar results would be achieved. All such similar substitutes and modifications apparent to those skilled in the art are deemed to be within the spirit, scope, and concept of the invention as defined by the appended claims.

What is claimed is:

1. A device for covering and protecting plants comprising:
a vertical support member; and
at least one arm member; and
two slider members;
wherein said arm members are connected to said slider members; and
wherein said slider members are connected to said vertical support member.

2. The device of claim 1, wherein said vertical support member is further comprised of slots running at least of portion of the length to allow the slider members to retain a fixed position on the vertical support member by locking into the slot.

3. The device of claim 1, wherein said vertical support member is further comprised of holes running at least of portion of the length to allow the slider members to retain a fixed position on the vertical support member by locking into the hole.

4. The device of claim 1, wherein said vertical support member is configured on the bottom end to be placed into or on the ground or soil allowing the device to remain upright.

5. The device of claim, wherein said vertical support member is configured on the bottom end to terminate in a spike to be placed into or on the ground or soil allowing the device to remain upright.

6. The device of claim 1, wherein said arm member is comprised of an upper arm member and a lower arm member.

7. The device of claim 6, further comprised of a cap member for each arm member connecting the upper arm member and the lower arm member.

8. The device of claim 7, where said cap member is comprised of a hinge allowing the upper arm member and the lower arm member to rotate in relation to each other.

9. The device of claim 1, further comprised of a covering member.

10. The device of claim 9, wherein said covering member is releasably attached to the other members.

11. The device of claim 9, wherein said covering members are releasably attached to said arm members.

12. The device of claim 9, wherein said covering members are releasably attached to said slider members.

13. The device of claim 9, wherein said covering members are releasably attached to said vertical support member.

14. The device of claim 9, wherein said covering members are a top side covering member, a left side covering member, a right side covering member, a back side covering member, and a front side covering member.

15. The device of claim 8, wherein each arm member has its upper arm member connected to the top slider member and the lower arm member is connected to the bottom slider member.

16. The device of claim 15, wherein said covering members are a top side covering member, a left side covering member, a right side covering member, a back side covering member, and a front side covering member.
